(19) United States
(12) Patent Application Publication
(10) Pub. No.: US 2007/0269553 A1
(43) Pub. Date: Nov. 22, 2007

(54) HEATED FOOD PRODUCT WITH COATING OF ENCAPSULATED FLAVORS

(76) Inventors: Anh Le, Middletown, DE (US); Jerome Barra, Neydens (FR); Catherine Maurel, Plan-Les-Ouates (CH); Jonathan F. Gordon, Wakefield, RI (US); Michael Chiaverini, Boulder, CO (US); Valery Normand, St-Jeoire-En-Faucigny (FR)

Correspondence Address: WINSTON & STRAWN LLP;PATENT DEPARTMENT, 1700 K STREET, N.W., WASHINGTON, DC, 20006, US

(21) Appl. No.: 11/832,936

(22) Filed: Aug. 2, 2007

Related U.S. Application Data
(63) Continuation of application No. PCT/IB06/50323, filed on Jan. 30, 2006.
(60) Provisional application No. 60/651,860, filed on Feb. 10, 2005.

(51) Int. Cl. A23G 4/00

(52) U.S. Cl. 426/3

(57) ABSTRACT

The present invention relates to a method for preparing a flavored food product, and to a method for reducing loss of flavors in a flavored product due to heat treatments. Loss of flavors by evaporation at high temperatures could be prevented by applying coating solutions in which water and encapsulated flavors have been mixed at 0.5% to 30 wt. % of capsules based on micro-organisms, a matrix component and encapsulated flavors. The coating solution was applied in high temperature coating processes or processes including heat treatment following the coating step and resulted in surprising retention of flavors in the coated food product.

### CROSS-REFERENCE TO RELATED APPLICATIONS

This application is a continuation of International application PCT/IB2006/050323 filed on Jan. 30, 2006, and claims the benefit of U.S. provisional application No. 60/651,860 filed on Feb. 10, 2005, the entire content of each of which is expressly incorporated herein by reference thereto.

### TECHNICAL FIELD

The present invention relates to a method for preparing a food product comprising flavors, to a method for increasing flavor performance in a flavored food product, and for reducing loss of flavors in a flavored food product due to heat treatments during the manufacturing or preparation process. The present invention further relates to a food product including flavoring microcapsules based on micro-organisms, a matrix component and at least one encapsulated flavor.

### BACKGROUND

Many of the processes in food industry involve prolonged periods of extreme thermal treatment. Flavors, on the other hand, are often highly volatile compounds and tend to evaporate from food products during thermal treatments. Moreover, intense heat may lead to further losses through the degradation of sensitive flavor molecules.

The problem of volatilisation of flavors in heat-treated food becomes even more significant in food products in which the flavor is applied by a coating, and in which the food product is subsequently subjected to a heat treatment, for example baking or toasting. In these food products or processes, losses due to the thermal treatment are particularly high. Generally, the temperature of a coating solution during coating is above 25° C., or even above 35° C. and may already lead to substantial flavor loss. If a further, even higher temperature treatment is to follow most of the flavors may be lost. The flavor loss can thus happen, for example in a food manufacturing facilities or, in the case of refrigerated pre-cooked food, during the step of final preparation in a restaurant or at home.

In EP 04100069.6 (unpublished) an edible product including flavoring microcapsules based on micro-organisms and at least one further carbohydrate material is disclosed. This encapsulation system was found to provide advantages to food products that have been heat-treated at temperatures above 70° C.

In EP 04103143.6 (unpublished) capsules based on micro-organisms and a carbohydrate matrix component are disclosed. These capsules are suitable also to encapsulate more hydrophilic functional agents, such as flavors.

EP 1252534 A1 discloses microcapsules wherein exogenous materials have been enclosed in the mycelium of micro-organisms, and wherein saccharides, proteins or sweeteners have been deposited on the surface of the micro-organism. However, the document specifies that the exogenous material may degenerate by heating, or that the flavor may disappear (page 13, lines line 29-33). These microcapsules are thus not a preferred solution for use in processes involving heat exposure.

In view of the prior art, it becomes an objective to provide a way for preventing flavor loss in processes involving heat treatments. It is a further objective to apply flavors to food products to the surface of a food product while reducing volatilisation of the flavor before consumption. The surface of the food product is the part that comes first in contact with the epithelial layers of the oral cavity in which flavor receptors are located. It is thus a specific objective to provide food products coated with flavors that withstand evaporation even under high temperatures, but which easily are released once arriving in the oral cavity.

### SUMMARY OF THE INVENTION

Remarkably, the inventors of the present invention found that if flavor-capsules based on a micro-organism, a matrix-component and at least one flavor are mixed with water and coated on food products, a surprising retention of flavors is obtained even though further processing steps involving high temperatures, such as drying, baking and/or toasting have occurred. Surprisingly, when suspended in aqueous solutions, the flavors encapsulated in a micro-organism and matrix component are not releaseed, as long as the aqueous solution is substantially free of oil or fat.

Accordingly, the present invention provides, in a first aspect, a method for preparing a food product comprising flavors, the method comprising the steps of
providing capsules based on a micro-organism, a matrix component and at least one encapsulated flavor,
mixing the capsules with water to obtain an aqueous suspension of capsules,
coating a food product with the aqueous suspension to obtain a coated food product, and,
drying, baking and/or toasting the coated food product.

In a further aspect, the present invention provides methods for increasing flavor performance in a flavored food product and reducing loss of flavors in a flavored food product due to heat treatments during the manufacturing or preparation process, which methods include the same process steps.

In another aspect, the present invention provides a food product comprising a coating comprising flavors, wherein the flavor is encapsulated in yeast cells and a matrix component.

In still another aspect, the present invention provides a food product including flavoring microcapsules formed of an encapsulated flavor ingredient or composition and an encapsulating material comprising a micro-organism and at least one carbohydrate material, said edible product being characterised in that it has been prepared by a process wherein an edible composition comprising the microcapsules has been subjected to a thermal treatment at a temperature in the range of 25° C. to 100° C., preferably 25° C. to 69° C.

### BRIEF DESCRIPTION OF THE DRAWINGS

FIG. 1 shows mean mint/cooling intensity of sugar-free chewing gums coated with encapsulated (A) and non-encapsulated mint flavor (B). Encapsulation refers to capsules comprising a flavor, a micro-organism and a matrix component. In both series, the same amount of mint flavor was applied onto the gums.

FIG. 2 shows mean lemon intensity of sugar-based chewing gums coated with encapsulated (A) and non-encapsulated lemon flavor (B). In both series, the same amount of lemon flavor was applied onto the gums.

### DETAILED DESCRIPTION OF THE PREFERRED EMBODIMENTS

In the context of the present invention, percentages are generally percentages by weight of dry matter, unless otherwise indicated, for example by reference to aqueous solutions or percentages of solids, where the percentages refer to parts of the total solution, including water.

The term “mean” as used, for example in the expression “mean diameter” refers to the arithmetic mean or average.

The term “flavor”, in the context of the present invention, may refer to a single flavoring molecule, or to a composition comprising several flavoring agents. Preferably, the term flavor composition refers to a composition of at least two flavor molecules preferably having different logP values. More preferably, the composition comprises at least one flavor compound with logP>2 and/or at least one flavor compound with logP≦2.

The term logP refers to the octanol/water partition coefficient of a specific functional agent to be encapsulated. For the purpose of the present invention, reference to a calculated logP (=clogP) value is made. This value is calculated by the software T. Suzuki, 1992, CHEMICALC 2, QCPE Program No 608, Department of Chemistry, Indiana University. See also T. J. Suzuki, Y. Kudo, J. Comput.-Aided Mol. Design (1990), 4, 155-198.

The term flavor also includes compounds that are perceived by mediation of the trigeminal nerve, such as cooling, salivating, pungent and tingling compounds, for example. Amongst the later, there can be cited molecules such as ethyl-3-p-menthanecarboxamide (available commercially from Millenium Chemicals Inc., under the tradename WS-3), 2-isopropyl-2,3-trimethylbutanamide (available commercially from Millenium Chemicals Inc., under the tradename WS-23), 3-(3-p-menthanyloxy)-1,2-propanediol (available commercially from Takasago Inc., under the tradename Coolact 10), isopulegol or 8-p-menthen-3-ol (available commercially from Takasago Inc., under the tradename Coolact P) and menthone glycerol ketal.

The term “flavor-capsules” or “capsules”, for the purpose of the present invention, refers to capsules based on a micro-organism, a matrix component and at least one encapsulated flavor.

“A micro-organism”, in the context of the present invention, does not refer to a single cell of a specific micro-organism. In contrast, the term also includes a multitude of individual micro-organisms or of different kinds of micro-organisms, for example, different kinds of yeasts.

The methods of the present invention comprise the step of providing capsules based on a micro-organism, a matrix component and at least one encapsulated flavor.

In order for the benefit from the advantageous properties in the processes of the invention to become apparent, at least part of the flavor needs to be enclosed within the cell wall of the micro-organism. Preferably, the flavors are within the cytoplasmic space of the micro-organism. The matrix component may be mixed with micro-organisms enclosing the flavor, followed by drying.

According to an embodiment of the present invention, the capsules based on a micro-organism, a matrix component and at least one flavor are prepared by a process comprising the steps of
a) mixing yeast with water to obtain an aqueous mixture,
b) adding a flavor to the aqueous mixture,
c) stirring the aqueous mixture including the flavor until at least part of the flavor has passed into the micro-organism,
d) adding the matrix component to the aqueous mixture comprising the at least partly encapsulated flavor, and,
e) drying the resulting mixture, or, alternatively, using the resulting mixture directly as an aqueous suspension of capsules in the process according to any of the preceding claims.

Steps a), b) and c) are familiar to the skilled person, for example from EP 1 454 534 A1, which discloses, in Example 1-6, the inclusion of flavorings in to yeast cell bodies. Similarly, J. R. P. Bishop et al. “Microencapsulation in yeast cells”, J. Microencapsulation, 1998, vol. 15, no. 6, 761-773, disclose the encapsulation of high concentrations of essential oils into bakers yeast. Accordingly, an aqueous suspension of yeast and oil is mixed, which allows the oil to pass freely through the cell wall and membrane and to remain passively within the cell.

Preferably, the aqueous mixture comprising the micro-organism and water is a suspension of 10-30, preferably 15-25 wt.-% solids, depending on type of organism and equipment used.

According to step b), at least one flavor is added to the aqueous mixture. Of course, the flavor could also be added earlier, for example, together with the yeast and the water. The flavor is usually present in a hydrophobic solvent, such as an essential oil or a flavor dissolved in an oil, and, therefore, the addition of the flavor may entail the formation of an emulsion. Accordingly, emulsifiers, surfactants and/or stabilisers may also be added to the aqueous liquid, for example. Preferably, the dry-weight ratio of micro-organism to flavor in the aqueous liquid is in the range of 1:1 to 5:1, preferably 1.4:1 to 4:1.

According to step c) the aqueous mixture comprising the micro-organism, water and the material to be encapsulated is then stirred for 1 to 6 hours, preferably. Stirring, in the context of the present invention also refers to actions like agitating or mixing.

According to step d), the matrix component is added to the aqueous mixture. As is listed in EP 04103143.6 a variety of possible matrix components may be used, which are all incorporated herein by reference. Preferably, the matrix component comprises a carbohydrate, more preferably, the matrix component comprises at least 50 wt. %, more preferably at least 80 wt. % of carbohydrates. Preferably, the carbohydrate forming the matrix component is water-soluble.

Preferably, the matrix component comprises dextrin, more preferably maltodextrin and/or corn syrup. Most preferably, the matrix component comprises maltodextrin and/or corn starch syrup having a mean dextrose equivalence of 5-25, preferably 6-20.

Step e) of the process provides drying of the resulting mixture, or, alternatively, f) using the resulting mixture directly as an aqueous suspension of capsules in the process of the present invention. Drying may be performed by spray drying, freeze drying, fluidised bed drying and/or oven drying, for example. Preferably, the drying step is performed by spray drying.

Following steps a) to e) given above, dried flavor capsules based on a micro-organism, a matrix component and at least one encapsulated flavor may be provided.

The flavor capsules based on a micro-organism and a matrix component as obtained above have substantial advantages over the prior art. In particular, they are advantageous over capsules devoid of a matrix component in that they are suitable to encapsulate flavor compositions comprising different flavor molecules having different hydrophobicity and/or hydrophilicity. In this event, the matrix component is suitable to withhold more hydrophilic flavors, while hydrophobic flavors are encapsulated within the yeast cell's plasma membrane, in particular, within the phospholipid bilayer. In this way, the capsules are suitable to provide a more round up flavor profile than capsules based on encapsulated yeast only, for example.

The present invention comprises the step of coating a food product with an aqueous suspension of the flavor capsules.

The term food product, in the context of the present invention, refers to any edible solid material designed for staying for some time in or passing the oral cavity. Thus, the term food product does not only refer to foods consumed for their nutritional value, but also products which are ingested for other purposes, for example pharmaceuticals, which may be orally consumed for health benefits or in order to alleviate a disease state, or which remain in the oral cavity to deliver oral care benefits. Additionally, the food product may simply be ingested for perceptional or organoleptic reasons, such as typically found with chewing gums, other sweets or refreshing pills or films.

In an embodiment of the present invention, the food product is selected from the group consisting of a chewing gum, a gummy, a compressed tablet, a cracker, a cookie, a cereal bar, a pet food, and a snack, for example a snack chip. Preferably, the food product is a chewing gum, a cracker, or a breakfast cereal.

Preferably, the food product, before a coating is applied, is present in a pre-cooked form, due to the fact that the present process comprises a further down-stream step of drying, baking and/or toasting the coated food product. For example, the food product may be a pre-baked cracker, onto which the aqueous suspension is sprayed, and which is toasted or dried thereafter, for example.

Preferably, the food products of the present invention have a water activity <0.7, more preferably <0.5 and most preferably <0.3. Products with lower water activity have better stability and are generally the direct result of the drying, baking and/or toasting steps of the present invention. Water activity in the context of the present invention may be determined by a Novasina, Type Aw Sprint RS50 apparatus, obtainable in Switzerland.

In a further step of the present invention, the capsules are mixed with water to obtain an aqueous suspension of capsules. Alternatively, the resulting mixture obtainable in step f) given above may be used directly, avoiding a drying step in between.

The term “aqueous suspensions” includes actual solutions or dispersions.

The spray dried capsules in the aqueous suspension, including the flavor, preferably provide 0.4 to 30 wt. %, preferably 0.8 to 20 wt. %, most preferably 1 to 5 wt % of the aqueous suspension. These percentages thus represent the dry matter of capsules per total weight of the solution, including water.

The aqueous suspension, however, may comprise further ingredients typically used for coating processes, such as sugars, polyols, soluble carbohydrates, hydrocolloids such as gum arabic, locust bean gum, xanthan gum, and/or coloring agents (lake or dyes) such as titanium dioxide, blue color, red color and yellow color.

The aqueous suspension preferably has up to 75 wt. % of solids, for example 1 to 70 wt. % of solids, including the capsules comprising the flavors.

In coatings for chewing gums, for example, the aqueous suspension preferably has about 50 to 70 wt % of solids. Accordingly, the aqueous suspension, which is used as a coating solution, preferably comprises about 0.5 to 3% by weight of the total solution of the flavor-capsules, the remainder of the solids being other coating constituents. The water content of the aqueous suspension may thus be in the range of about 30 wt. % to 99.5 wt. %.

Preferably, the aqueous suspension only contains very small amounts of possibly emulsified oils and/or fats other than those being part of the flavor capsules. For example, the aqueous suspension comprises less than 3 wt. %, preferably less than 2 wt. % oil and/or fat. More preferably, the aqueous suspension is free of oils and fats.

The inventors of the present invention have observed that little or no oil and/or fat in the aqueous suspension are a prerequisite for flavor retention within the flavor capsules of the present invention.

For the same reason, according to an embodiment of the present invention, the food product is not a product intended for frying in oil, and/or the food product is a product in which the steps of drying, baking and/or toasting the coated food product excludes frying.

The process of the present invention further provides the step of coating a food product with the aqueous suspension to obtain a coated food product. The step of coating the food product with the aqueous suspension may be performed with usually coating or spraying equipment, for example conventional coating pans, side-vented pan coaters, coating drums, fluid bed coaters, for example, with appropriate coating guns. Coating guns include a spraying nozzle suitable to disperse the aqueous solution including the capsules onto the food product, such as an un-cooked or pre-cooked cracker, for example. A typical spraying apparatus suitable for coating the aqueous suspension on a cracker would be a Binks® 95G Gravity Speed Spray Gun, obtainable from Binks MFG Co., Belmont, USA.

The coating step may be a repetitive process, which permits to obtain thicker coatings composed of a multitude of thin individual coatings. These composed coatings may thus comprise higher loads of the capsules of the present invention. The coating step may be performed at any temperature, depending on the nature of the coating process.

Preferably, the coating is performed at ambient or at elevated temperatures (>25° C.).

In an embodiment of the present invention, the step of coating the food product is performed for a period of 1 minute to 10 hours. Preferably, the step of coating is performed for a period of 2 minutes to 7 hours. In another embodiment of the present invention, the coating is performed by spraying and/or painting the aqueous solution onto the food product, and/or by dipping the food product in the coating solution.

Examples for food products onto which the aqueous solution comprising the flavor-capsules are painted are biscuits, crackers, snacks, bars, cakes, rolls, pastry, dough, frozen dough, and frozen bakery products, for example. The painting can be made with any brush system suitable to paint food-grade ingredients.

Examples for food products which may be coated by dipping the food product into the aqueous solution comprising the flavor-capsules are biscuits, crackers, snacks, bars.

The present invention further provides a step of drying, baking and/or toasting the coated food product. If the coating was done at elevated temperatures (above 25° C.), the drying step actually has been performed in the coating-equipment and forms part of the coating step. In this case, no further drying under elevated temperatures may be required. Alternatively, if the coating has been performed under ambient conditions (<=25° C.), a drying, baking or toasting step at elevated temperatures may be performed.

Drying may be performed in any drying equipment adapted to the specific coated food product to be dried. Examples for drying equipments are fluidised bed driers and oven dryers, for example. Generally, the skilled person knows the drying time and temperature required for obtaining a dried coated product. Typically, the drying step is performed at temperatures in the range of 50 to 300° C., preferably 100 to 250° C. for a time of 30 s to 3 hours, depending on the product size. Examples of products that require a drying step are coated chewing gums, compressed tablets, crackers, cookies, cereal bars, extruded cereals, not extruded cereals, pet foods, and snacks.

In a preferred embodiment of the present invention, the drying, baking and/or toasting is performed at temperatures in the range from above 25 to 280° C. Baking may be performed in any oven suitable to bake the coated food product. Generally, the skilled person knows the baking time and temperature required for obtaining a baked product of a given product category and size. Typically, the baking step is performed at temperatures in the range of 50 to 300° C., preferably 100 to 250° C., for a time of 30 s to 3 hours, depending on the product size.

Examples for baking equipments are different kinds of ovens, such as conveyor ovens, tray ovens, electric ovens, rack ovens, reel ovens, tunnel ovens, impingement ovens and the like. Examples of products that require a baking step are cookies, crackers, breads, rolls and biscuits.

Toasting may be performed in any equipment suitable to toast the coated food product. Generally, the skilled person knows the toasting time and temperature required for obtaining a baked product of a given product category and size. Typically, the toasting step is performed at temperatures in the range of 50 to 350° C., preferably 110 to 300° C. for a time of 30 s to 10 minutes, depending on the product size.

Examples for toasting equipments are different kinds of toasters and/or ovens, for example the ovens mentioned above, or typical toasters. Generally, toasting and baking may be performed in similar equipment, while the toasting generally refers to an exposure for a shorter time to higher temperatures, leading to a browning of the food product's surface, within a short time of maximally about ten (10) minutes. Examples of products that require a toasting step are snacks, crackers, breads, croutons, cereals, and pastries.

In the context of the present invention, the terms drying, baking and/or toasting, preferably refer to processes during which a coated food product is exposed to hot air, basically with the purpose of rendering the product more palatable or in order to increase the storage time and stability of the coated food product. For example, the step of drying, baking and/or toasting may have the purpose or effect of removing water from the coated food product, thus rendering the product more stable. However, under conditions other than those of the present invention, the exposure to hot air entail a loss of volatile flavors by evaporation.

In an alternative embodiment of the present invention the terms drying, baking and/or toasting also refer to processes during which a coated food product is not exposed to hot air, for example in a microwave oven, basically with the purpose of rendering the product more palatable and/or in order to increase the storage time and stability of the coated food product.

In an embodiment of the present invention, the drying, baking and/or toasting is performed at temperatures in the range of above 25-280° C., preferably 45-250° C. Preferably, the food product of the present invention has preferably been subjected to a thermal treatment at a temperature in the range of 30° C. to 100° C., more preferably 35 to 69° C. More preferably, this temperature has been applied for at least 3 hours.

In an embodiment the process of the present invention further comprises the step of refrigerating or freezing the food product, before the step of drying, baking and/or toasting the coated food product. Refrigerating refers to a process wherein the food product is exposed to a temperature of <11, preferably <6° C. Freezing refers to a process wherein the food product is exposed to a temperature of 0 or less ° C.

Accordingly, the process of the present invention is suitable to prepare typical chilled or frozen foods, which may be commercially obtained in a chilled or frozen form, and which may be cooked, dried, baked, and/or tasted by an individual at home or in a restaurant, for example. The products of the present invention include thus convenient food, which can be quickly prepared from the basis of a pre-cooked product, for example.

The process steps of the present invention are suitable to prepare food products comprising flavors. Furthermore, the process steps were shown to increase flavor performance in a flavor food product, and to reduce loss of flavors in a flavored food product due to heat treatments during manufacturing.

In an embodiment of the food product of the present invention, the coating is a water-based coating. Preferably, the water-based coating comprises water, which in the further processing of the food product is removed, and capsules based on a micro-organism, a matrix component and at least one flavor. The removal of the water may occur by drying, baking and/or toasting the coated food product. Preferably, the coating of the food product is basically free of fat and/or oil.

In an embodiment, the food products of the present invention are susceptible to be obtained by the process of the present invention

### EXAMPLES

Further advantages will become apparent from the following examples, which describe some embodiments of the present invention in a more detailed manner without limiting the scope of the present invention.

### Example 1

### Preparation of Capsules Based on Yeast, Maltodextrin and Encapsulated Flavors

100 g spray-dried yeast (Aventine Renewable Energy Company, USA) were dispersed in 375 g water. 75 g of flavor (NovaMint Freshmint®, commercially obtainable from Firmenich SA, Switzerland, commercial no. 506038T) are added and the mixture is maintained for 4 hours at 50° C. under constant agitation at 150 rpm in a blade stirrer.

Thereafter, 150 g of maltodextrin (DE 18) was added and mixed until the total aqueous mixture was homogenous.

The mixture was then spray dried on a Niro mobile minor® at 210° C. inlet and 90° C. outlet temperature at a feed rate of 10 ml/minute. A powder of capsules based on a micro-organism, a matrix component and at least one flavor are obtained.

The same procedure is repeated with a butter flavor instead of the mint flavor. Accordingly, 75 g of butter flavor (commercial no: 758904 06101TTB0440) commercially obtainable from Firmenich, Switzerland, was used in the same procedure as outlined above, to obtain butter flavor encapsulated in capsules based on a micro-organism and a matrix component.

### Example 2

### Sugar-Free Chewing Gums Coated with Flavor-Capsules Based on a Micro-Organism and a Matrix Component

Sugar-free chewing gum pellets were prepared with the ingredients given below:

| Ingredients | Percent (%) |
|---|---|
| Gum base (Cafosa Gum Base Co., Spain) | 30.00 |
| Crystalline sorbitol powder | 53.85 |
| Mannitol powder | 4.00 |
| Sorbitol 70% solution | 10.00 |
| Glycerine | 2.00 |
| Acesulfame potassium | 0.05 |
| Aspartame | 0.10 |
| Total | 100.00 |

Crystalline sorbitol, mannitol, acesulfame potassium and aspartame are dry blended forming a powder of blended sweeteners. Half of the sweetener's blend was added to a sigma-blade mixer. The gum base is heated to soften it and added to the sigma blade mixer (equipped with heated water jacket to perform the mixing at a temperature of about 55° C.) and mixed for 2 min. Thereafter, the remaining sweetener's blend and all liquid ingredients (sorbitol 70% solution and glycerine) are added to the mixer and further mixed for 7 min. After a total mixing time of 12 minutes, the unflavored gum base is removed, shaped to the desired thickness and passed through a pellets forming machine (LWS80 of Hermann Linden, Maschinenfabrik GmbH & Co KG, Germany) to make small chewing gum pellets of 1 g each.

A polyol coating solution for sugar-free chewing gum at 60-65 wt. % solids was prepared in a Pyrex® glass beaker by mixing water with isomalt (95 wt. % of solids), gum Arabic (2 wt. % of solids), TiO₂ (2 wt. % of solids) and 1 wt. % of the mint-flavored capsules obtained in Example 1 in a Euro-STD mixer obtained from EuroStar, IKA® Werke GmbH & Co KG, Germany, and kept at the temperature of about 55° C.

The polyol solution was pumped by an automatic pump (Type CD-70, Verder Lab Tech GmbH, Germany) at about 55° C. to the sugar free chewing gum pellets in a Brucks®-coating pan (Bruccoma L/GII, Germany), by providing 10 ml-units of coating solution to the chewing gum pellets about every 5 minutes for applying a total of 47 coating layers.
Pan speed: 55-60
Air blower: 60-65%
Inlet air: 15-20° C.
Outlet air: 20-25° C.
Room temperature: 20-25° C., less than 35-40% relative humidity
Spraying: 10 ml of sugar-free coating syrup at 55-60° C.
Distribution: 5 minutes
Drying: 5 minutes
Coating layers: 47

After about 7 hours, the coating process was completed and the coating made up 30-33 wt. % of the coated chewing gum pellets. The coated pellets had a weight of about 1.5 g.

The same process was repeated but instead of 1 wt. % (of solids) of the capsules, 0.2% of liquid mint-flavor (see Example 1) was added to the coating solution, which corresponds to an iso-load of liquid flavor in the chewing gums obtained with encapsulated and non-encapsulated flavor. The remaining 0.8 wt. % to make up 100% of ingredients of the coating solution with the non-encapsulated flavors was negligible and therefore ignored.

The chewing gums thus obtained were tested by a panel of 20 persons and intensity perceived by each panellist was recorded over 2 min. and 30 s.

The trained panellists participated in one tasting session and tested two samples each, which were presented in a blind and randomised manner. The intensity of the cooling/mint taste was evaluated on a 0 to 10 linear scale from absent to strong. A Student's t-test was performed to identify significant differences between the two samples.

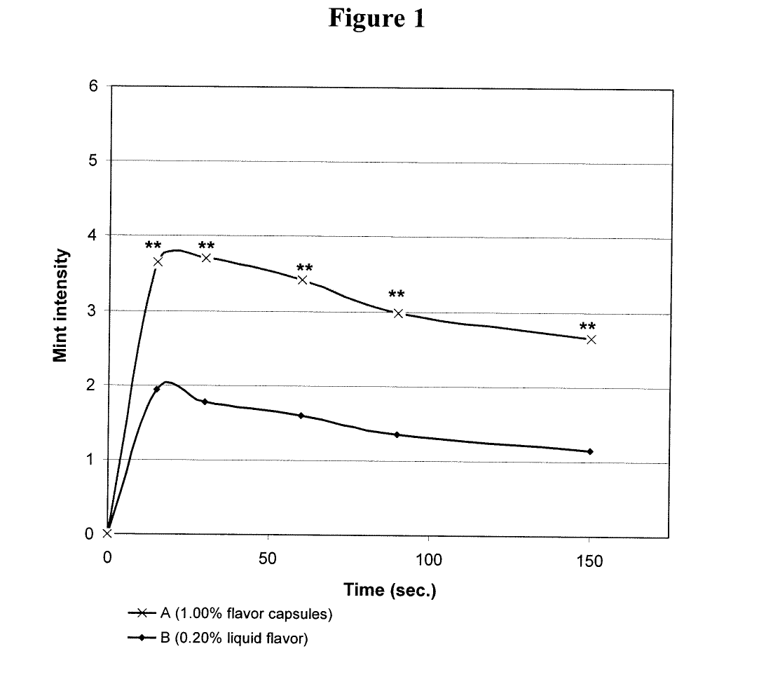

FIG. 1 shows mean intensity of chewing gums coated with encapsulated (A) and non-encapsulated flavor (B).

It can be seen from FIG. 1 that sugar-free chewing gums coated with encapsulated (yeast and carbohydrate matrix, see Example 1) flavors had significantly higher intensity than chewing gums coated with the same amount of non-encapsulated (liquid) flavors.

### Example 3

### Sugar-Based Chewing Gums Coated with Flavor-Capsules Based on a Micro-Organism and a Matrix Component

Sugar-based chewing gum pellets were prepared with the ingredients given below:

| Ingredient | wt. % |
|---|---|
| Gum base (Cafosa Gum Base Co., Spain) | 30 |
| Sucrose powder | 60 |
| Glycerine | 10 |
| Total | 100 |

Half of the sucrose is added to a sigma-blade mixer as used in Example 2, and the gum base is heated to soften and added to the mixer, followed by mixing for 2 min. The remaining sucrose and the glycerine are added to the mixer and further mixed for 7 minutes.

The unflavored gum base was removed, shaped into desired thickness and passed through the LWS80 pellets forming machine (Hermann Linden, Maschinenfabrik GmbH & Co. KG, Germany) to make small gum pellets (1 gram in weight).

A coating solution was prepared according to Example 2, but sugar (96 wt. % of solids) was used instead of isomalt. As a further difference, the coating solution was heated to 35-40° C. only and was kept at this temperature during the entire coating process.

Again, one batch of coating solution was prepared in which the 2 wt. % (of solids) of encapsulated flavor was replaced by 0.4 wt. % of liquid flavor, resulting in an iso-load of flavor in sugar-based chewing gums coated with encapsulated (A) and non encapsulated (B) flavors.

The process parameters of the Bruck® coating machine are given below:
Pan speed: 55-60 rpm
Air blower: 60-65%
Inlet air: 20-25° C.
Outlet air: 20-25° C.
Room temperature: 20-25° C., less than 35-40% relative humidity
Spraying: 10 ml of sugar-based coating syrup at 35-40° C.
Distribution: 5 minutes
Drying: 5 minutes
Coating layers: 46

The coating was continued for a total time of about 7 hours, during which 46 individual coatings (total of 10 ml per layer) were applied. At the end of the process, the final weight of the coated chewing gum pellets was about 1.5 g, meaning that about 33 wt. % of the pellets is made up by the coating.

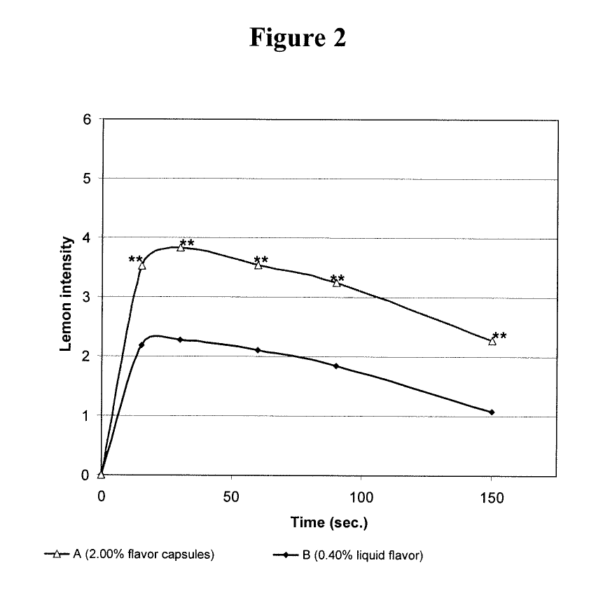

The taste evaluations were performed in the same way as in Example 2. FIG. 2 shows mean intensity of sugar-based chewing gums coated with encapsulated (A) and non-encapsulated flavor (B).

It can be seen from FIG. 2 that sugar-based chewing gums coated with encapsulated (A: yeast and carbohydrate matrix, see Example 1) flavors had significantly higher intensity than chewing gums coated with the same amount of non-encapsulated (liquid) flavors (B).

### Example 4

### Breakfast Cereals Coated with Flavors

Breakfast cereals (Kix®, crispy corn puffs, manufactured by General Mills, USA) were commercially obtained and coated with different liquid and encapsulated flavor for comparing the flavor intensity.

The flavors used were strawberry and honey flavor compositions, commercially obtainable from Firmenich SA, Switzerland with experimental numbers 765385 05NT and 758904 04301T, respectively.

Strawberry and honey-flavored capsules based on yeast, maltodextrin and encapsulated flavors were made according to the procedure of Example 1 with the flavor compositions indicated above.

Different coating solutions (200 g each) having iso-loads of the same flavor were prepared based on the quantities below:

| | |
|---|---|
| Encapsulated honey flavor: | 3.33 g |
| Liquid honey flavor: | 0.67 g |
| Encapsulated strawberry flavor: | 5.33 g |
| Liquid strawberry flavor: | 1.07 g |

The coating solutions were prepared by heating 200 g of sucrose syrup 68° Brix to 57° C., adding each of the different flavors to a coating solution and mixing well. The solutions were held at 57° C. for 2 hours and stirred occasionally, to obtain two pairs of different coating solutions of 200 g, each pair having an isoload of strawberry and honey flavor respectively.

Breakfast cereal (170 g) was placed in a rotating drum and 30 g of the pertinent coating solution was slowly added. After rotating at 25° C. for 5 min. the coating was completed. The coated cereals were dried in a continuous belt oven for 5 min. at 104° C. to 3 wt. % moisture content, cooled to room temperature and stored in plastic Ziploc® bags.

The breakfast cereals obtained by water based coating of liquid- and yeast and maltodextrin encapsulated flavors at isoloads had the following final composition (wt. %):

| | |
|---|---|
| Honey flavor, encapsulated: | 0.25% |
| Honey, liquid: | 0.05% |
| Strawberry, encapsulated: | 0.4% |
| Strawberry, liquid: | 0.08% |

The cereals were tasted by three expert tasters after mixing with cold milk. The cereal coated with encapsulated strawberry flavors had a considerably stronger profile than that of the liquid flavor. Also the cereal having a coating with encapsulated honey flavor had a stronger flavor than its liquid flavored counterpart, however, the difference was slightly less noticeable.

In conclusion, by encapsulating flavors in yeast cells and applying a further carbohydrate matrix, flavors were better retained if applied within a water-based coating solution to breakfast cereals at elevated temperature and/or followed by a heat treatment, such as drying. Encapsulated flavors provided stronger flavor profiles despite the high temperature coating and/or drying process.

### Example 5

### Baked Crackers Spray-Coated with Encapsulated Flavors

A water-based flavor coating solution was prepared. The coating solution contained 1 wt. % of the encapsulated butter flavor prepared in Example 1.

Unbaked crackers are prepared according to the ingredients given below:

| Ingredients | Weight percent |
|---|---|
| Wheat Flor, all purpose | 54.82 |
| Sucrose | 2.74 |
| Non-fat milk solids | 0.91 |
| Pregelatinised corn starch | 2.74 |
| Inactive dry yeast | 0.55 |
| Salt (sodium chloride) | 0.91 |
| Sodium bicarbonate | 0.32 |
| Monocalcium phosphate | 0.73 |
| Vegetable shortening, partially hydrogenated | 9.14 |
| Ammonium bicarbonate | 1.10 |
| Water | 26.04 |

The unbaked crackers were prepared by first dissolving ammonium bicarbonate in water and separately mixing all dry ingredients including the fat. Then, all dry ingredients are added to a Hobart(® mixer and mixed for 4 minutes. Thereafter, the water-ammonium bicarbonate mixture is added, and the whole mixture is mixed again for 2 minutes.

After mixing, the resulting dough is allowed to rest at room temperature for 15 minutes and sheeted to 2 mm thickness. 8.3 g of the coating solution was spread on 240 g of unbaked cracker dough mixture with a brush. After the coating with flavors, the dough is cut into uniform pieces (3 cm×3 cm) and baked in a continuous oven for 6:30 minutes at 171° C. to produce crackers. The crackers are allowed to cool at ambient temperature and are placed in moisture-proof packages.

Four days after packaging, the butter flavor intensity of the crackers was tested by three expert taste testers and was found to have excellent butter flavor.

The results of Examples 2-5 are contrary to the statements of the prior art, according to which yeast-encapsulated flavors were held unsuitable for exposure to high temperatures.

What is claimed is:

1. A method for preparing a food product comprising flavors, the method comprising the steps of
providing capsules based on a micro-organism, a matrix component and at least one encapsulated flavor,
mixing the capsules with water to obtain an aqueous suspension of capsules,
coating a food product with the aqueous suspension to obtain a coated food product, and,
drying, baking and/or toasting the coated food product.

2. The process according to claim 1, wherein said aqueous suspension of capsules, before and/or during the process of coating, is heated and/or kept at a temperature in the range of 25-70° C.

3. The process according to claim 1, wherein said step of coating the food product is performed for a period of 1 minute to 10 hours.

4. The process according to claim 1, wherein said drying, baking and/or toasting is performed at temperatures in the range of above 25-280° C.

5. The process according to claim 1, wherein said coating is performed by spraying and/or painting the aqueous solution onto the food product, and/or by dipping the food product in the coating solution.

6. The process according to claim 1, wherein said food product is selected from the group consisting of a chewing gum, a gummy, a compressed tablet, a cracker, a cookie, a cereal bar, a pet food, and a snack.

7. The process according to claim 1, wherein said food product is not a product intended for frying in oil, and/or the food product is a product in which the steps of drying, baking and/or toasting the coated food product excludes frying.

8. The process according to claim 1, further comprising the step of refrigerating or freezing the food product, before the step of drying, baking and/or toasting the coated food product.

9. The process according to claim 1 in which said capsules based on a micro-organism, a matrix component and at least one flavor are prepared by a process comprising the steps of
a) mixing yeast with water to obtain an aqueous mixture,
b) adding a flavor to the aqueous mixture,
c) stirring the aqueous mixture including the flavor until at least part of the flavor has passed into the micro-organism,
d) adding the matrix component to the aqueous mixture comprising the at least partly encapsulated flavor, and,
e) drying the resulting mixture, or, alternatively,
f) using the resulting mixture directly as an aqueous suspension of capsules.

10. A food product comprising a coating comprising flavors, wherein the flavor is encapsulated in yeast cells and a matrix component.

11. A food product comprising obtainable according to the process of claim 1.

12. A food product comprising obtained by the process of claim 1.
